(19) United States
(12) Patent Application Publication
(10) Pub. No.: US 2009/0167637 A1
(43) Pub. Date: Jul. 2, 2009

(54) ELECTRONIC DEVICE WITH OPTICAL DISC DRIVE AND DIGITAL PHOTO FRAME

(75) Inventors: LUNG DAI, Tu-Cheng (TW); JIE LIU, Shenzhen City (CN); HAI-LAN DU, Shenzhen City (CN); TSUN-HO KE, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/340,756

(22) Filed: Dec. 22, 2008

(30) Foreign Application Priority Data
Dec. 29, 2007 (CN) 200710203573.4

(51) Int. Cl. G09G 3/00; H04N 5/00

(52) U.S. Cl. 345/30; 386/126; 386/E05.064

(57) ABSTRACT

An exemplary electronic device includes an optical disc drive, a digital photo frame, and a connector mounted on the optical disc drive and cooperating with the optical disc drive to form two slide rails holding the digital photo frame in position. The digital photo frame includes a display panel for selectively displaying the digital photos or the video information, and a selection module. The selection module is for transmitting data corresponding to the digital photos to the display panel for display when the selection module does not receive the video information from the optical disc drive, and transmitting the video information to the display panel for display when the selection module receives the video information from the optical disc drive.

### BACKGROUND

1. Field of the Disclosure

The present disclosure relates to electronic devices, and particularly to an electronic device capable of displaying digital photos and reproducing video information.

2. Description of Related Art

In recent years, various consumer electronic devices, such as digital versatile disc (DVD) players, and digital photo frames, have been used in entertainment. These consumer electronic devices serve people well. For instance, a DVD player is configured for reading information from an optical disc and reproducing the information via a display panel; and a digital photo frame is configured for storing digital photos and displaying the digital photos without the need to print them or use a computer. However, one kind of consumer electronic device cannot be used to execute the specific functions of another kind. Taking the aforementioned cases as examples, the DVD player cannot store digital photos and the digital photo frame cannot read an optical disc and reproduce video information.

Therefore if people want to watch DVD video information and view digital photos, they need two separate electronic devices. This may be a substantial burden or inconvenience for some people.

An improved electronic device is needed to address the aforementioned deficiencies and inadequacies.

### BRIEF DESCRIPTION OF THE DRAWINGS

FIG. 1 is an isometric view of an electronic device in accordance with an exemplary embodiment of the present invention.

FIG. 2 is an exploded isometric view of the electronic device of FIG. 1.

FIG. 3 is a block diagram illustrating physical and functional structure of the electronic device of FIG. 1.

### DETAILED DESCRIPTION OF EMBODIMENTS

Reference will now be made in detail to exemplary embodiments of the present invention, at least some of which are illustrated in the accompanying drawings.

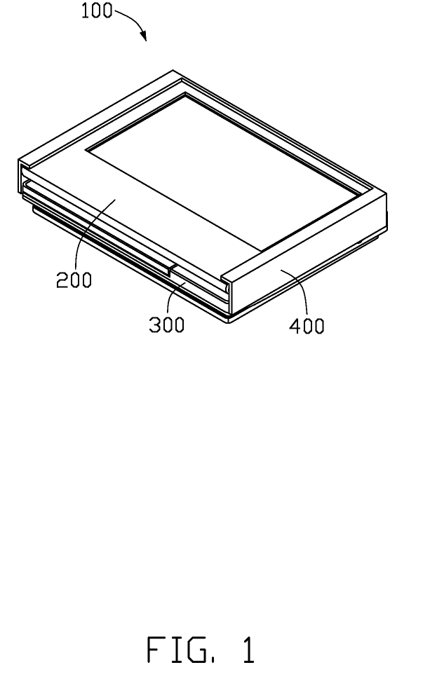

Referring to FIG. 1, an electronic device 100 is configured for not only reading video information from optical discs and reproducing the video information, but also storing digital photos and displaying the digital photos. A mechanical structure of the electronic device 100 includes a digital photo frame 200 for displaying the digital photos, an optical disc drive 300 for reproducing video information, and a connector 400 for connecting the digital photo frame 200 to the optical disc drive 300. The optical disc drive 300 and the digital photo frame 200 both have a generally box-shaped, parallelepiped, or cuboidal shape.

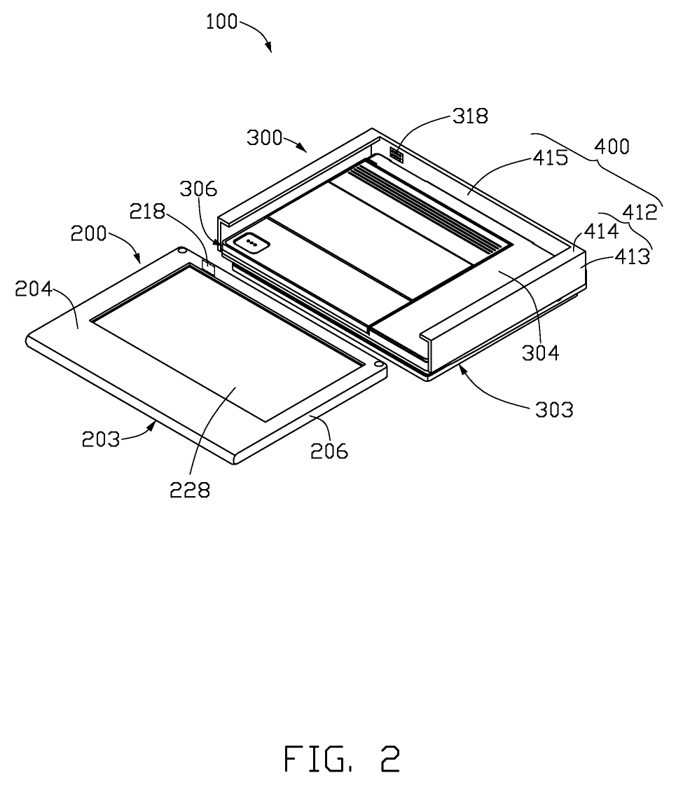

Referring also to FIG. 2, the optical disc drive 300 includes a first lower surface 303, a first upper surface 304, two first side surfaces 306, and a video-output interface 318. Likewise, the digital photo frame 200 includes a second lower surface 203, a second upper surface 204, two second side surfaces 206, and a video-input interface 218. The digital photo frame 200 defines an opening (not labeled) in the second upper surface 204, so as to expose a display panel 228 thereof. The video-input interface 218 is disposed at a back wall (not labeled) of the digital photo frame 200.

The connector 400 is generally in the form of a U-shaped frame, and is fixed on the optical disc drive 300. The connector 400 includes two opposite side panels 412, and a back wall 415. The side panels 412 are parallel to each other. The back wall 415 interconnects the side panels 412. The video-output interface 318 is formed on an inner surface (not labeled) of the back wall 415, corresponding to the video-input interface 218. The video-output interface 318 is electronically connected to the optical disc drive 300 by a cable (not labeled) behind the back wall 415. Each side panel 412 includes a side wall 413 and an upper flange 414. The upper flanges 414 extend perpendicularly from top sides of the side walls 413 toward each other. The side walls 413 and the back wall 415 of the connector 400 abut against the first side surfaces 306 and a back surface (not labeled) of the optical disc drive 300. In one embodiment, the side walls 413 and the back wall 415 of the connector 400 are interferingly engaged with the first side surfaces 306 and the back surface (not labeled) of the optical disc drive 300. Thus the connector 400 is attached to the optical disc drive 300. The upper flanges 414 are parallel with the first upper surface 304 of the optical disc drive 300. Each side wall 413, the upper flange 414 above the side wall 413, and the first upper surface 304 cooperatively to form a slide rail (not labeled). The slide rails allow the digital photo frame 200 to slide into position on top of the digital photo frame 200.

When the digital photo frame 200 has been slidingly received in the connector 400, the video-input interface 218 of the digital photo frame 200 is connected to the video-output interface 318 of the optical disc drive 300. The second lower surface 203 of the digital photo frame 200 abuts against the first upper surface 304 of the optical disc drive 300. The second side surfaces 206 of the digital photo frame 200 abut against the side walls 413 of the connector 400. Inner surfaces (not labeled) of the upper flanges 414 of the connector 400 abut against the second upper surface 204 of the digital photo frame 200. The display panel 228 is exposed for viewing for users via a space (not labeled) between the two upper flanges 414. Thus, the digital photo frame 200 is fittingly engaged in the slide rails and thereby held in position on top of the digital photo frame 200.

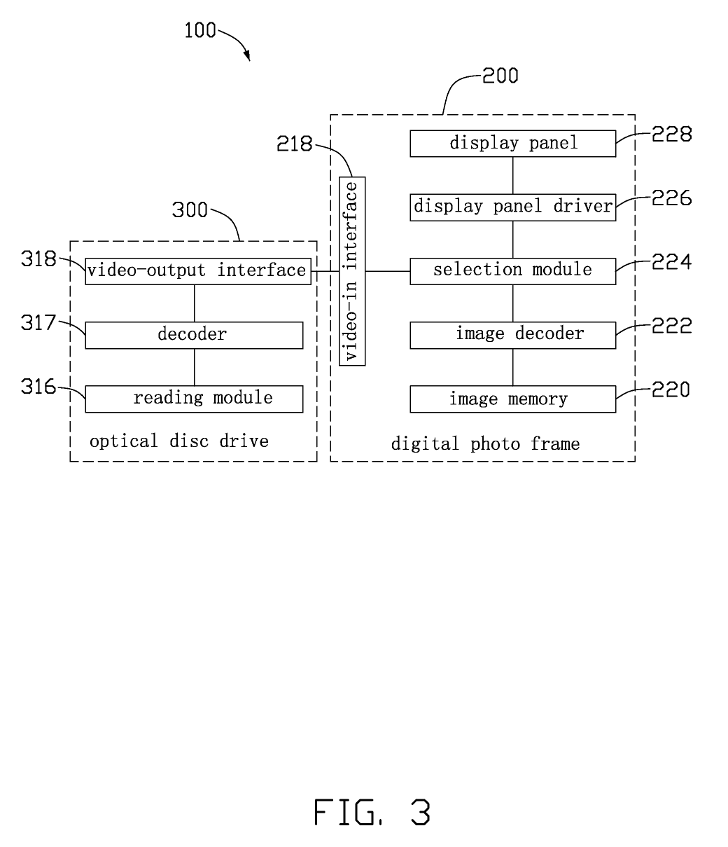

Referring to FIG. 3, a block diagram of physical and functional structure of the electronic device is shown. The optical disc drive 300 includes a reading module 316, a decoder 317, and the video-output interface 318. The reading module 316 is configured for reading video information from an optical disc loaded in the optical disc drive 300. The decoder 317 is used for decoding the video information from the reading module 316. The video-output interface 318 is configured for outputting the video information to the digital photo frame 200 after the video information has been decoded by the decoder 317.

The digital photo frame 200 includes the video-input interface 218, an image memory 220, an image decoder 222, a selection module 224, a display panel driver 226, and the display panel 228. The video-input interface 218 is configured for receiving the video information from the video-output interface 318. The image memory 220 is configured for storing the digital photos. The image memory 220 may be an internal storage or an external storage connected to the digital photo frame 200. The image decoder 222 is configured for decoding the digital photos stored in the image memory 220. The selection module 224 is configured for selectively transmitting either the video information from the video-input interface 218 or the digital photos from the image decoder 222 to the display panel driver 226. In this embodiment, a default setting of the selection module 224 is such that it transmits the digital photos from the image decoder 222 to the display panel driver 226. When the selection module 224 detects the video information, the selection module 224 discontinues transmitting the digital photos, and switches to transmitting the video information. The display panel driver 226 is configured for driving the display panel 228 to display the digital photos or the video information.

The electronic device 100 connects the digital photo frame 200 to the optical disc drive 300 via the connector 400, and the selection module 224 determines whether to display the digital photos or the video information. Therefore the electronic device 100 is convenient to carry and set where desired, and provides more functions.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electronic device, comprising:
an optical disc drive;
a digital photo frame; and
a connector mounted on the optical disc drive, and cooperating with the optical disc drive to form two slide rails at opposite sides of the optical disc drive, the slide rails capable of holding the digital photo frame in position and allowing the digital photo frame to be slid out from or into position.

2. The electronic device of claim 1, wherein the connector comprises two side panels and a back wall, and the back wall interconnects the two side panels.

3. The electronic device of claim 2, wherein each side panel comprises an upper flange and a side wall, the upper flange extending from the top of the side wall.

4. The electronic device of claim 3, wherein the optical disc drive comprises a first upper surface, and the first upper surface and the side panels cooperatively form the two slide rails.

5. The electronic device of claim 3, wherein the optical disc drive further comprises two side surfaces at opposites sides thereof and the side walls of the connector are attached to the first side surfaces.

6. The electronic device of claim 5, wherein the side walls of the connector are interferingly attached to the side surfaces of the optical disc drive.

7. The electronic device of claim 3, wherein the digital photo frame comprises two side surfaces which abut against the side walls of the connector when the digital photo frame is held in position.

8. An electronic device, comprising:
an optical disc drive configured for reading and decoding video information from an optical disc; and
a digital photo frame configured for storing digital photos and displaying the digital photos, the digital photo frame comprising:
a display panel configured for selectively displaying digital photos or video information; and
a selection module configured for transmitting data corresponding to the digital photos to the display panel for display when the selection module does not receive the video information from the optical disc drive, and transmitting the video information to the display panel for display when the selection module receives the video information from the optical disc drive.

9. The electronic device of claim 8, wherein the optical disc drive comprises a reading module configured for reading video information from the optical disc, and a decoder configured for decoding the video information from the reading module.

10. The electronic device of claim 9, wherein the optical disc drive further comprises a video-output interface capable of outputting the video information from the decoder to the digital photo frame.

11. The electronic device of claim 10, wherein the digital photo frame comprises a video-input interface capable of receiving the video information from the video-output interface of the optical disc drive.

12. The electronic device of claim 8, wherein the digital photo frame further comprises an image memory configured for storing digital photos.

13. The electronic device of claim 12, wherein the digital photo frame further comprises an image decoder configured for decoding the digital photos from the image memory.

14. The electronic device of claim 8, wherein the digital photo frame further comprises a display panel driver configured for driving the display panel to display the video information and the digital photos.
